(19) United States
(12) Patent Application Publication
(10) Pub. No.: US 2002/0153088 A1
(43) Pub. Date: Oct. 24, 2002

(54) Method for manufacturing a rough-surfaced plastic sheet

(76) Inventors: Rong-Tong Chen, Tainan Hsien (TW); Chin-Tai Lin, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/840,160

(22) Filed: Apr. 24, 2001

(51) Int. Cl. B32B 1/00

(52) U.S. Cl. 156/244.11; 156/244.19

(57) ABSTRACT

A method for manufacturing rough-surfaced plastic sheet is based on technique, using cooperative extrusion by means of two or more extrusion machines. A main extrusion machine is for forming a main body of a plastic sheet. One or two auxiliary extrusion machine are for forming one or two rough-surface layers with plastic material, pigment and processing agent, which are melted and mixed together inside to let the foaming agent in the barrel generate bubbles and explode at the same time to form the plastic into one or two rough-surfaced layers. Then, after the main body and the rough-surfaced together pass through a mold head, the rough-surfaced layer adheres to one or two outer surfaces of the main body, cooled at once to form a plastic board with one or two rough surfaces, thus heightening producing efficiency, lowering investment coat and elevating competitive force.

### BACKGROUND OF THE INVENTION

This invention relates to a method for manufacturing rough-surfaced plastic sheets, possible to make use of conventional extrusion equipment for manufacturing a rough-surfaced plastic sheet at one round of operation, elevating producing efficiency and lowering investment cost.

A rough-surfaced plastic sheet has widely been used as liner for leather suitcases and cushions applied in construction and civil engineering on account of its property of increasing friction against other substances.

Conventional methods for manufacturing a rough-surfaced plastic sheet are roughly classified into three methods:

1. After a smooth-surfaced plastic sheet is formed with extrusion process, it is compressed with heat into a rough-surfaced plastic sheet having curved irregular lines or designs by means of a rolling compressor. .

2. After a smooth-surfaced plastic board is formed with extrusion process, it is moved to pass through spraying equipment filled with melted plastic material so that the melted plastic material may adhere on the smooth surface of the plastic sheet giving rise to roughness of its surface.

3. After a smooth-surfaced plastic sheet is formed with extrusion process, it is coated on its surface with foaming plastic material in a way of film lamination to let foaming plastic material adhere to the surface of the plastic sheet, obtaining effect of roughness of its surface.

However, these three kinds of conventional methods for manufacturing rough-surfaced plastic sheets have to involve two processes, thus complicating manufacturing processes, wasting much time in manufacturing and so failing to enhance producing efficiency.

In recent years, in order to promote efficiency in producing a rough-surfaced plastic sheet, manufacturers have researched and developed equipment and manufacturing methods, by which a rough-surfaced plastic sheet can be made with only one process. That is, a way of cooperative extrusion process is adopted, requiring at least two extrusion machines and one nitrogen injection system. Plastic material for forming one or two rough surface is firstly molded by one or more extrusion machines, and then high pressured nitrogen is injected into the rear portion of the barrel of the extruder to let the nitrogen mix with melted plastic material by the screw of the extruder, then the mixture is pushed to the mold, the huge pressure drop causes the nitrogen gas instantly to segregate from melted plastic material to explode out of the outer surface of the melted plastic material, which is at once cooled and solidified so as to form a rough surface on an outer surface of the main body.

The manufacturing method with help of the gas mentioned above makes a rough-surfaced plastic sheet with one round of the manufacturing process, but the equipment used in the manufacturing method needs to be designed in particular, thus increasing investment cost in machinery equipment and failing to elevate competitive force.

### SUMMARY OF THE INVENTION

The objective of the invention is to offer a method for manufacturing rough-surfaced plastic boards, mainly based on technique of cooperative extrusion by means of two or more extrusion machines.

A main extruder is to form the main body of a plastic sheet made from plastic, mixed with pigment and processing agent, and an auxiliary extruder is to form a rough-faced layer made with plastic material, mixed with pigment, processing agent and a proper amount of foaming agent. After the foaming agent is heated and decomposed in the barrel of the auxiliary extruder, it generates gas enough to form plastic bubbles and explode at the same time to form a rough outer surface of the main body of a plastic sheet. Then the rough inner and outer surfaces become a rough-surface plastic sheet after cooled.

In accordance with the manufacturing method of this invention, a rough-surfaced plastic sheet can be molded in shape with only one round of extrusion process, thus enhancing producing efficiency, and possible to lower investment cost and promote competitive force because conventional extrusion machines are usable for the method in the invention, requiring no additional expense for the equipment.

### BRIEF DESCRIPTION OF THE DRAWINGS

This invention will be better understood by referring to the accompanying drawings, wherein:

FIG. 1 is a diagram showing processes of manufacturing a rough-surfaced plastic sheet of the present invention:

FIG. 2 is a perspective view of a finished plastic sheet with two rough surfaces of the present invention:

FIG. 3 is a diagram of the processes of manufacturing a rough-surfaced plastic sheet of the present invention:

FIG. 4 is a perspective view of a finished plastic sheet with only one rough surface of the present invention.

### DETAILED DESCRIPTION OF THE PREFERRED EMBODIMENTS

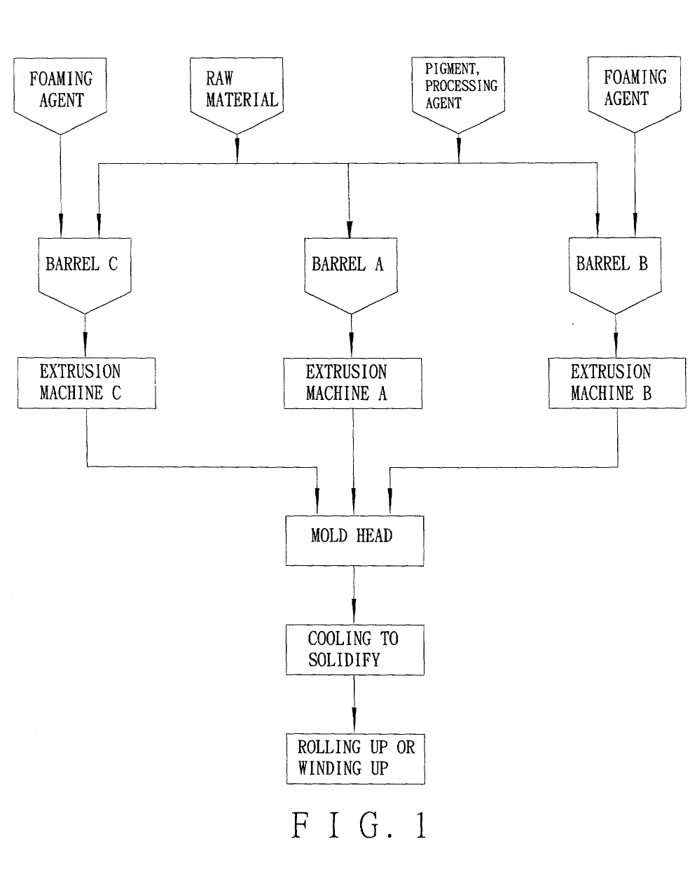

A method for manufacturing a rough-surfaced plastic sheet in the present invention, as shown in FIG. 1, is mainly based on technique of cooperative extrusion, using two or more conventional extrusion machines, one main and one or two auxiliary ones.

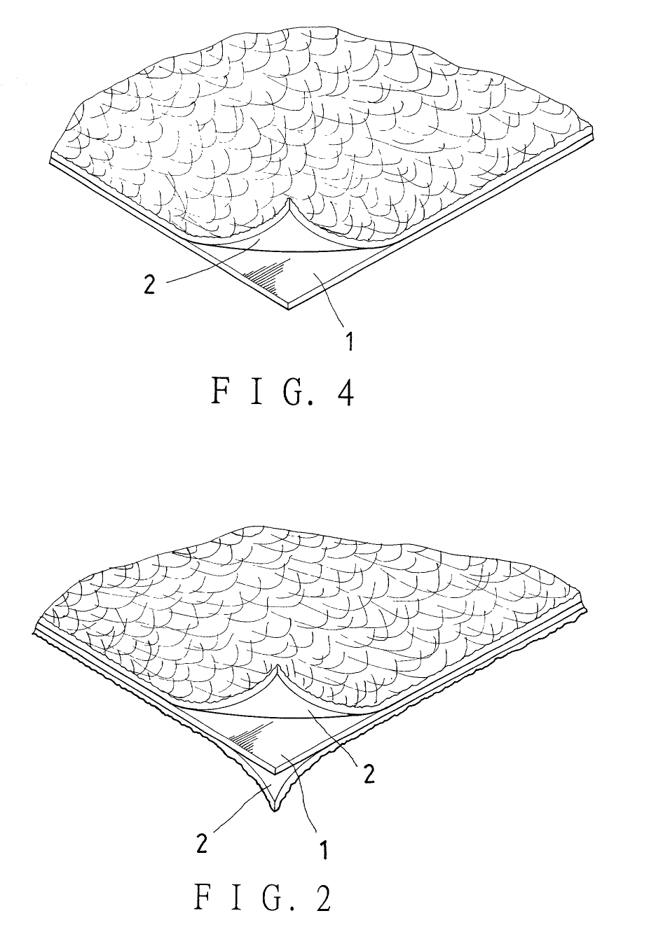

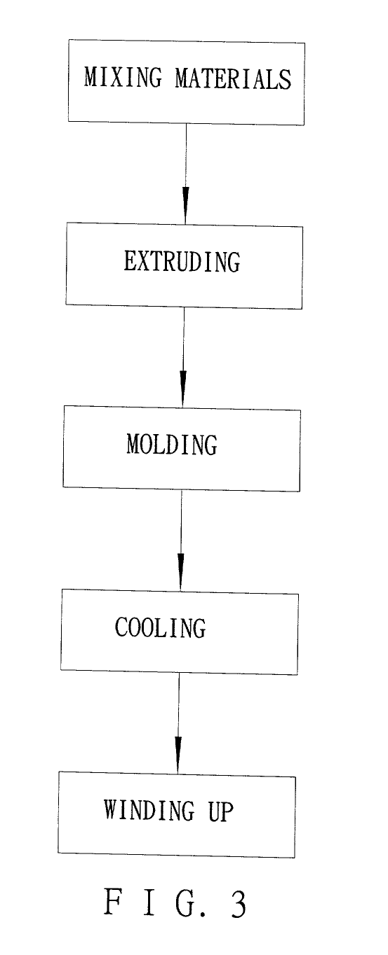

The barrel of the main extrusion machine A is fed with plastic material, pigment and processing agent, then the mixture is mixed and melted together therein by the screw to form a main body 1 of a plastic sheet, as shown in FIG. 2. The two auxiliary extrusion machines B and C have their barrels fed with plastic material, pigment, processing agent and proper amount of foaming agent, which are melted and mixed together therein by the screw, and after the foaming agent in the barrel is heated to decompose, it generates bubbles and explode so as to form a rough-surfaced layer 2.

The steps of manufacturing a rough-surfaced plastic sheet with the extrusion machines in the present invention are as follows:

1. Mixing material: Plastic material, pigment and processing agent are mixed together, and fed into the barrel of the main extruder A, and then mix a proper amount of foaming agent together with the same materials as mentioned above and feed this mixture into the barrel of the auxiliary extruders B and C.

2. Extrusion: The plastic material, the pigment and the processing agent in the barrel of the main extruder A are melted, mixed together, and to form a smooth main body 1, and then the same materials as mentioned mixed with the foaming agent are melted together in the barrel of the auxiliary extruders B and C. Then, after the added foaming agent is heated to decompose and generate gases large enough to form many plastic bubbles and explode at the same time, forming a rough-surfaced layer 2.

3. Molding: Both the main body 1 and the two rough-surfaced layers 2 are pushed to a mold head, and, after passing together through the mold head, the rough-surfaced layers 2 respectively adheres to both sides of the main body 1, forming a plastic sheet with two rough surfaces.

4. Cooling, rolling up and cutting into units: The successively molded rough-surfaced plastic boards are cooled, rolled up and then cut into units with a preset size.

Besides, if the main extrusion machine of this invention matches with only one auxiliary extrusion machine 2, one outer layer 2 molded by the auxiliary extrusion machine and the main body 1 molded by the main extrusion machine 1 pass through the mold head, but the rough-surfaced layer 2 only attaches to one side of the main body 1, as shown in FIG. 4, forming a plastic board with one rough surface.

Furthermore, if the main extrusion machine matches with only one auxiliary extrusion machine, a dividing device can be installed to divide the rough-surfaced layer 2 molded by the auxiliary extrusion machine into two rough-surfaced layers 2, which pass together with the main body 1 through the mold head, and adhere to both sides of the main body 1, forming a plastic sheet with two rough surfaces.

Additionally, degree of roughness of the outer surface of the plastic sheet depends on both the amount of foaming agent added to the material mixture and elasticity of the melted plastic material, so a plastic sheet with one or two outer surfaces having a preset roughness can be acquired by choosing a proper foaming agent and suitable plastic material and by controlling process of temperature.

As can be understood from above description, by the manufacturing method of this invention, plastic sheets can successively be molded by repeating one round of molding process, elevating producing efficiency, and besides, conventional extrusion machines can be used for manufacturing a rough-surfaced plastic sheet, and foaming agent is needed only in small amount, available on market, requiring less cost on material. On the whole, it needs no additional investment on the equipment, thus lowering investment cost and enhancing competitive force.

What is claimed is:

1. Method for manufacturing rough-surfaced plastic sheet comprising,
one main conventional extrusion machine used for forming a main body of a smooth plastic sheet; plastic material, pigment and processing agent mixed together to be filled in a barrel of said main extrusion machine, melted and mixed therein to extrude and mold a main body of a plastic sheet,
one or two auxiliary extrusion machines filled with plastic material, pigment, processing agent and a proper amount of foaming agent, which are melted and mixed together in a barrel of said auxiliary extrusion machine(s), said foaming agent heated to decompose and produce gas large enough to let said plastic material form many bubbles and explode to form a rough-surfaced layer to be adhered on one or two sides of said main body;
steps of manufacturing said rough-surfaced plastic sheets consisting of:
(1). Mixing materials: Plastic material, pigment and processing agent mixed, melted together and fed into said barrel of said main extrusion machine A, a proper amount of foaming agent mixed in said material mixture and fed into said barrel of said auxiliary extrusion machine(s) B (and C);
(2) Extrusion : Said plastic material, said pigment and said processing agent melted and mixed together in said barrel of said main extrusion machine, and is extruded to form a smooth main body of a plastic sheet; said plastic material, said pigment, said processing agent and said foaming agent melted and mixed together in said barrels of said auxiliary extrusion machines B and C, letting said foaming agent heated to decompose and produce gas with its amount large enough to form many bubbles and explode at the same time, thus a rough-surfaced layer formed on said plastic;
(3). Molding in shape: Said main body and said rough-surfaced layer moved to said mold head and passing through said mold to let said rough-surfaced layer adhere to two sides of said main body to form a plastic sheet with two rough surfaces;
(4). Cooling, rolling up and cutting into units: Said rough-surfaced plastic boards successively formed, rolled up and cut into units with a preset size;
said rough-surfaced plastic sheet finished one by one in forming through one round of molding process, promoting producing efficiency, lowering investment coat and elevating competitive force.

2. The method for manufacturing rough-surfaced plastic sheet as claimed in claim 1, wherein when said main extrusion machine matches with only one said auxiliary extrusion machine, and when said rough-surfaced layer formed by said auxiliary extrusion machine and said main body formed by said main extrusion machine together pass through said mold head, permitting said rough-surfaced layer adhere to only one side of said main body to form a plastic sheet with one rough surface.

3. The method for manufacturing rough-surfaced plastic sheet as claimed in claim 1, wherein, when said main extrusion machine matches with only one said auxiliary extrusion machine, said rough-surfaced layer molded by said auxiliary extrusion machine then divided into two rough-surfaced layers by means of a divide device, said rough-surfaced layers passing together with said main body through said mold, adhering to both sides of said main body, forming a plastic sheet with two rough surfaces.
